(19) United States
(12) Patent Application Publication
(10) Pub. No.: US 2023/0342381 A1
(43) Pub. Date: Oct. 26, 2023

(54) SHARED INTELLIGENT VIRTUAL ASSISTANT

(71) Applicant: META PLATFORMS TECHNOLOGIES, LLC, Menlo Park, CA (US)

(72) Inventors: Yiming Pu, Santa Clara, CA (US); Kiran Mascarenhas, Bellevue, WA (US); Gabrielle Catherine Moskey, San Mateo, CA (US)

(21) Appl. No.: 17/474,977

(22) Filed: Sep. 14, 2021

(51) Int. Cl. G06F 16/332; G06F 16/338; G06F 16/33; G06F 16/335

(52) U.S. Cl. CPC G06F 16/3329; G06F 16/338; G06F 16/3331; G06F 16/335

(57) ABSTRACT

Methods, systems, and storage media for sharing intelligent virtual assistants among group members are disclosed. Exemplary implementations may: receive, from a first member of a group, a request to invoke an intelligent virtual assistant, responsive to receiving the request to invoke the intelligent virtual assistant, invoke an intelligent virtual assistant associated with an account of the first member of the group, receive a query requesting a response from the intelligent virtual assistant associated with the first member of the group, and cause presentation of a response to the received query for consumption by each member of the group.

### TECHNICAL FIELD

The present disclosure generally relates to intelligent virtual assistants. More particularly, the present disclosure relates to sharing use of an intelligent virtual assistant among a plurality of members of a group.

### BACKGROUND

Intelligent personal assistants are increasing in popularity as the number of tasks and services such intelligent personal assistants are capable of performing increases. Through text, voice, and/or other modalities, an intelligent personal assistant can receive a query (e.g., a command or a question) from a user having an account associated with the intelligent personal assistant and respond to the querying user by performing the command and/or answering the question presented. Unfortunately, conventional intelligent personal assistants offer limited capabilities for collaboration among individuals.

### BRIEF SUMMARY

The subject disclosure provides for systems and methods for sharing an intelligent virtual assistant among a plurality of members of a group. One member of the group may invoke an intelligent personal assistant associated with an account of the invoking member and all members of the group may share in the consumption of a response to any query made of the intelligent personal assistant. For instance, a first group member may, in the context of a group chat, invoke their associated intelligent personal assistant and make a query to that assistant. The intelligent personal assistant may determine an appropriate response to the query and cause display of the response to all members of the group chat.

One aspect of the present disclosure relates to a method for sharing intelligent virtual assistants among a plurality of group members. The method may include receiving, from a first member of the plurality of group members, a request to invoke an intelligent virtual assistant. The method may include, responsive to receiving the request to invoke the intelligent virtual assistant, invoking an intelligent virtual assistant associated with an account of the first member of the plurality of group members. The method may include receiving a query requesting a response from the intelligent virtual assistant associated with the account of the first member of the plurality of group members. The method may include causing presentation of a response to the received query for consumption by each member of the plurality of group members.

Another aspect of the present disclosure relates to a system configured for sharing intelligent virtual assistants among a plurality of group members. The system may include one or more hardware processors configured by machine-readable instructions. The processor(s) may be configured to receive, from a first member of the plurality of group members, a request to invoke an intelligent virtual assistant. The processor(s) may be configured to, responsive to receiving the request to invoke the intelligent virtual assistant, invoke an intelligent virtual assistant associated with an account of the first member of the plurality of group members. The processor(s) may be configured to receive a query requesting a response from the intelligent virtual assistant associated with the account of the first member of the plurality of group members. The processor(s) may be configured to identify the plurality of group members. The processor(s) may be configured to collect data for at least a portion of the identified plurality of group members. The processor(s) may be configured to determine a response to the received query based, at least in part, on the collected data. The processor(s) may be configured to cause presentation of the determined response to the received query for consumption by each member of the identified plurality of group members.

Yet another aspect of the present disclosure relates to a non-transient computer-readable storage medium having instructions embodied thereon, the instructions being executable by one or more processors to perform a method for sharing intelligent virtual assistants among a plurality of group members. The method may include receiving, from a first member of the plurality of group members, a request to invoke an intelligent virtual assistant. The method may include, responsive to receiving the request to invoke the intelligent virtual assistant, invoking an intelligent virtual assistant associated with an account of a first member of the plurality of group members. The method may include receiving a query requesting a response from the intelligent virtual assistant associated with the account of the first member of the plurality of group members. The method may include causing presentation of a response to the received query for consumption by each member of the plurality of group members.

Still another aspect of the present disclosure relates to a system configured for sharing intelligent virtual assistants among a plurality of group members. The system may include means for receiving, from a first member of the plurality of group members, a request to invoke an intelligent virtual assistant. The system may include, responsive to receiving the request to invoke an intelligent virtual assistant, means for invoking an intelligent virtual assistant associated with an account of the first member of the plurality of group members. The system may include means for receiving a query requesting a response from the intelligent virtual assistant associated with the account of the first member of the plurality of group members. The method may include means for causing presentation of a response to the received query to each member of the plurality of group members.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system configured for sharing intelligent virtual assistants among a plurality of group members, in accordance with one or more implementations of the disclosure.

FIG. 2 illustrates an exemplary flow diagram for sharing intelligent virtual assistants among a plurality of group members, according to certain aspects of the disclosure.

FIG. 3 illustrates another exemplary flow diagram for sharing intelligent virtual assistants among a plurality of group members, according to certain aspects of the disclosure.

FIG. 4 is a block diagram illustrating an exemplary computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

Intelligent personal assistants are increasing in popularity as the number of tasks and services such intelligent personal assistants are capable of performing increases. Through text, voice, and/or other modalities, an intelligent personal assistant can receive a query (e.g., a command or a question) from a user having an account associated with the intelligent personal assistant and respond to the querying user by performing the command and/or answering the question presented. Unfortunately, conventional intelligent personal assistants offer limited capabilities for collaboration among individuals. For instance, a group of individuals that are seeking a restaurant where they can have lunch together can each independently navigate through a search engine or app, or ask an intelligent virtual assistant associated with their respective individual accounts, in an attempt to determine a suitable location but can do so only as a solitary activity, even when they are in the same room or engaged in a group chat or the like. The results that each individually determines then may be shared with the group (e.g., through a group chat or the like) only to discover that multiple group members have performed the same searches and/or queries and thus the results are repetitive and as a result of unnecessary administrative activity. Further, the act of determining a restaurant for lunch has become an individual activity diminishing the collaborative component of deciding upon a restaurant.

The subject disclosure provides for systems and methods for sharing an intelligent virtual assistant among a plurality of members of a group. One member of the group may invoke an intelligent personal assistant associated with an account of the invoking member and all members of the group may share in the presentation of a response to any query made of the intelligent personal assistant.

Implementations described herein address these and other problems by providing a collaborative means for utilizing an intelligent personal assistant associated with an account of an individual member of a group for the benefit of all members of the group. Members of a group may be in a collaborative discussion regarding a topic relevant to all group members. One member of the group may query an intelligent personal assistant associated with an account of the one group member, within the context of the collaborative discussion, and the intelligent personal assistant may present a response to the query such that all members of the group may consume the response. By way of non-limiting example, a query may be received in the context of a group chat and the response may be textually displayed within the group chat such that all group members may view the response. By way of non-limiting example, a query may be received through a head mounted augmented and/or virtual reality device and the response may be displayed within the associated augmented and/or virtual reality environment, consumable by any member of a group utilizing the appropriate head mounted augmented and/or virtual reality device or that is otherwise able to view the content displayed in the augmented and/or virtual reality environment.

The disclosed methods and systems address a problem of traditional intelligent virtual assistants tied to computer technology, namely, the technical problem of collaborative sharing of personal virtual assistant responses. The disclosed systems and methods solve this technical problem by providing a solution also rooted in computer technology, namely, by providing for the ability to present responses received from individual intelligent personal assistants for consumption by a plurality of members of a group.

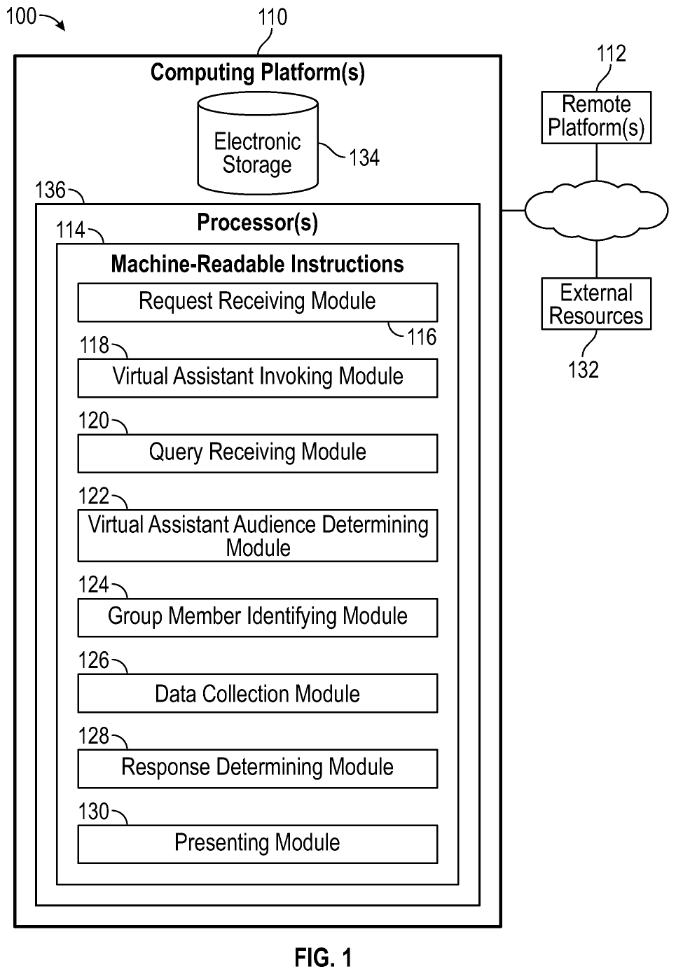

FIG. 1 illustrates a system 100 configured for sharing virtual assistants among a plurality of group members, according to certain aspects of the disclosure. Sharing intelligent virtual assistants may include receiving queries from one member of a plurality of group members, collecting information about the plurality of group members and utilizing the collected information to formulate an appropriate response to a query, and/or presenting a response to a received query for consumption by a plurality of group members. In some implementations, system 100 may include one or more computing platforms 110. Computing platform(s) 110 may be configured to communicate with one or more remote platforms 112 according to a client/server architecture, a peer-to-peer architecture, and/or other architectures. Remote platform(s) 112 may be configured to communicate with other remote platforms via computing platform(s) 110 and/or according to a client/server architecture, a peer-to-peer architecture, and/or other architectures. Users may access system 100 via remote platform(s) 112.

Computing platform(s) 110 may be configured by machine-readable instructions 114. Machine-readable instructions 114 may include one or more instruction modules. The instruction modules may include computer program modules. The instruction modules may include one or more of request receiving module 116, intelligent virtual assistant invoking module 118, query receiving module 120, intelligent virtual assistant audience determining module 122, group member identifying module 124, data collecting module 126, response determining module 128, presenting module 130, and/or other instruction modules.

Request receiving module 116 may be configured receive one or more requests to invoke an intelligent virtual assistant. In aspects, requests to invoke an intelligent personal assistant may be received from a first member of a plurality of group members. In aspects, requests to invoke an intelligent virtual assistant may be received in accordance with the format or modality in which it is desired that the intelligent personal assistant respond to queries and/or commands. By way of non-limiting example, a request to invoke an intelligent virtual assistant may be received from within the context of a group chat when it is desired that the intelligent virtual assistant provide query and/or command responses within the context of the group chat for consumption by all members of the group chat. By way of non-limiting example, a request to invoke an intelligent virtual assistant may be received from with the context of an augmented and/or virtual reality environment when it is desired that the personal assistant provide query and/or command responses within the context of the augmented and/or virtual reality environment for consumption by a group of members having an appropriate head mounted augmented and/or virtual reality device or app that permits a group member to view what is being viewed by the group members having the appropriate head mounted augmented and/or virtual reality device even without the appropriate device.

Intelligent virtual assistant invoking module 118 may be configured to invoke an intelligent virtual assistant associated a member of a plurality of group members. In aspects, an intelligent virtual assistant associated with an account of a member of the plurality of group members that requested that the intelligent virtual assistant be invoked may be invoked. By way of non-limiting example, an intelligent virtual assistant associated with an account of a first member of the plurality of group members may be invoked when the first member of the plurality of group members requested the invocation of an intelligent virtual assistant.

Query receiving module 120 may be configured to receive a query requesting a response from an intelligent virtual assistant associated with an account of the intelligent virtual assistant invoking group member. By way of non-limiting example, if a request to invoke an intelligent virtual assistant is received from a first member of a plurality of group members, a received query may be requesting a response from an intelligent virtual assistant associated with an account of the first member of the plurality of group members. In aspects, the query may be received from the intelligent personal assistant invoking member of the plurality of group members. In aspects, the query may be received from a member of the plurality of group members other than the intelligent personal assistant invoking member of the plurality of group members. By way of non-limiting example, an intelligent personal assistant that has been invoked by a first member of a plurality of group members in an augmented and/or virtual reality environment may receive a query from any member of the plurality of group members from within the context of the augmented and/or virtual reality environment.

Intelligent virtual assistant audience determining module 122 may be configured to determine that the intelligent virtual assistant associated with the account of the invoking member of the plurality of group members was invoked for each member of the plurality of group members. In aspects, the intelligent virtual assistant audience determining module 122 may be configured to determine that the intelligent virtual assistant associated with the account of the invoking member of the plurality of group members was invoked for each member of the plurality of group members by determining, based upon a context from which the query was received, that the intelligent virtual assistant associated with the account of the invoking member of the plurality of group members was invoked for each member of the plurality of group members. By way of non-limiting example, if the context from which the query was received was a group chat context, the intelligent virtual assistant audience determining module 122 may be configured to determine that the intelligent virtual assistant was invoked for the benefit of each member of the group chat. By way of non-limiting example, if the context from which the query was received was an augmented and/or virtual reality environment, the intelligent virtual assistant audience determining module 122 may be configured to determine that the intelligent virtual assistant was invoked for the benefit of anyone in the immediate environment that is utilizing the appropriate head mounted augmented and/or virtual reality device.

In aspects, the intelligent virtual assistant audience determining module 122 may be configured to determine that the intelligent virtual assistant associated with the account of the invoking member of the plurality of group members was invoked for each member of the plurality of group members by determining, based upon used of a wake word, that the intelligent virtual assistant associated with the account of the first member of the plurality of group members was invoked for each member of the plurality of group members. By way of non-limiting example, when an invoking member of a plurality of group members desires for the intelligent virtual assistant associated with the account of the invoking member to be for the benefit of all members of the group, the request to invoke the intelligent virtual assistant and/or the query may be preceded by a wake word such as “Hey Shared Virtual Assistant” as opposed to “Hey Virtual Assistant” when the request to invoke the intelligent virtual assistant and/or the query is intended only for the invoking member of the plurality of group members.

Group member identifying module 124 may be configured to identifying the plurality of group members. In aspects, the group member identifying module 124 may be configured to identify the plurality of group members based upon a context from which the request to invoke the intelligent virtual assistant was received. In aspects, the group member identifying module may be configured to identify the plurality of group members utilizing one or more sensors of a virtual and/or augmented reality device to detect at least a portion of the plurality of group members.

Data collecting module 126 may be configured to collect data for at least a portion of the plurality of group members. By way of non-limiting example, the data collecting module 126 may be configured to collect data for at least a portion of the plurality of group members utilizing one of more of a profile associated with a social media account of a member of the plurality of group members, preferences associated with a social media account of a member of the plurality of group members, content commented on, posted, and/or otherwise associated with a member of the plurality of group members in regards to one or more social media accounts, GPS data available from an electronic device associated with a member of the plurality of group members, and the like. It will be understood by those having ordinary skill in the art that the information accessible by the data collecting module 126 can vary and any such information is intended to be within the scope of embodiments of the present disclosure.

Response determining module 128 may be configured to determine the response to the received query for each member of the plurality of group members based, at least in part, on the collected data. By way of non-limiting example, if a plurality of members of a group are interested in finding a restaurant in which to have lunch, the response determining module 128 may be configured to utilize collected GPS data indicating a current location of one or more of the group members to determine a suitable restaurant.

Presenting module 130 may be configured to cause presentation of a response to a received query for consumption by each member of the plurality of group members. In aspects, the presenting module 130 may be configured to cause presentation of a response to a received query based, at least in part, upon a context in which at least one of a request to invoke an intelligent assistant or a query is received.

In some implementations, computing platform(s) 110, remote platform(s) 112, and/or external resources 132 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 110, remote platform(s) 112, and/or external resources 132 may be operatively linked via some other communication media.

A given remote platform 112 may include one or more processors configured to execute computer program modules. The computer program modules may be configured to enable an expert or user associated with the given remote platform 112 to interface with system 100 and/or external resources 132, and/or provide other functionality attributed herein to remote platform(s) 112. By way of non-limiting example, a given remote platform 112 and/or a given computing platform 110 may include one or more of a server, a desktop computer, a laptop computer, a handheld computer, a tablet computing platform, a NetBook, a Smartphone, a gaming console, and/or other computing platforms.

External resources 132 may include sources of information outside of system 100, external entities participating with system 100, and/or other resources. In some implementations, some or all of the functionality attributed herein to external resources 132 may be provided by resources included in system 100.

Computing platform(s) 110 may include electronic storage 134, one or more processors 136, and/or other components. Computing platform(s) 110 may include communication lines, or ports to enable the exchange of information with a network and/or other computing platforms. Illustration of computing platform(s) 110 in FIG. 1 is not intended to be limiting. Computing platform(s) 110 may include a plurality of hardware, software, and/or firmware components operating together to provide the functionality attributed herein to computing platform(s) 110. For example, computing platform(s) 110 may be implemented by a cloud of computing platforms operating together as computing platform(s) 110.

Electronic storage 134 may comprise non-transitory storage media that electronically stores information. The electronic storage media of electronic storage 134 may include one or both of system storage that is provided integrally (i.e., substantially non-removable) with computing platform(s) 110 and/or removable storage that is removably connectable to computing platform(s) 110 via, for example, a port (e.g., a USB port, a firewire port, etc.) or a drive (e.g., a disk drive, etc.). Electronic storage 134 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 134 may include one or more virtual storage resources (e.g., cloud storage, a virtual private network, and/or other virtual storage resources). Electronic storage 134 may store software algorithms, information determined by processor(s) 136, information received from computing platform(s) 110, information received from remote platform(s) 112, and/or other information that enables computing platform(s) 110 to function as described herein.

Processor(s) 136 may be configured to provide information processing capabilities in computing platform(s) 110. As such, processor(s) 136 may include one or more of a digital processor, an analog processor, a digital circuit designed to process information, an analog circuit designed to process information, a state machine, and/or other mechanisms for electronically processing information. Although processor(s) 136 is shown in FIG. 1 as a single entity, this is for illustrative purposes only. In some implementations, processor(s) 136 may include a plurality of processing units. These processing units may be physically located within the same device, or processor(s) 136 may represent processing functionality of a plurality of devices operating in coordination. Processor(s) 136 may be configured to execute modules 116, 118, 120, 122, 124, 126, 128, and/or 130, and/or other modules. Processor(s) 136 may be configured to execute modules 116, 118, 120, 122, 124, 126, 128, and/or 130, and/or other modules by software; hardware; firmware; some combination of software, hardware, and/or firmware; and/or other mechanisms for configuring processing capabilities on processor(s) 136. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 116, 118, 120, 122, 124, 126, 128, and/or 130 are illustrated in FIG. 1 as being implemented within a single processing unit, in implementations in which processor(s) 136 includes multiple processing units, one or more of modules 116, 118, 120, 122, 124, 126, 128, and/or 130 may be implemented remotely from the other modules. The description of the functionality provided by the different modules 116, 118, 120, 122, 124, 126, 128, and/or 130 described below is for illustrative purposes, and is not intended to be limiting, as any of modules 116, 118, 120, 122, 124, 126, 128, and/or 130 may provide more or less functionality than is described. For example, one or more of modules 116, 118, 120, 122, 124, 126, 128, and/or 130 may be eliminated, and some or all of its functionality may be provided by other ones of modules 116, 118, 120, 122, 124, 126, 128, and/or 130. As another example, processor(s) 136 may be configured to execute one or more additional modules that may perform some or all of the functionality attributed below to one of modules 116, 118, 120, 122, 124, 126, 128, and/or 130.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

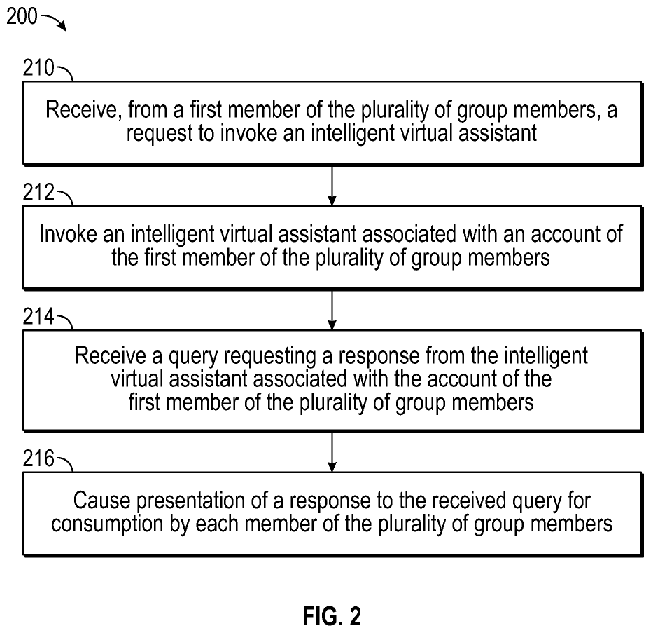

FIG. 2 illustrates an example flow diagram (e.g., process 200) for sharing intelligent virtual assistants among a plurality of group members, according to certain aspects of the disclosure. For explanatory purposes, the exemplary process 200 is described herein with reference to FIG. 1. Further for explanatory purposes, the steps of the exemplary process 200 are described herein as occurring in serial, or linearly. However, multiple instances of the exemplary process 200 may occur in parallel.

At step 210, the process 200 may include receiving, from a first member of a plurality of group members, a request to invoke an intelligent virtual assistant. According to aspects, the request to invoke the intelligent virtual assistant may be received in the context of a group communication (e.g., a group chat). According to aspects, the request to invoke the intelligent virtual assistant may be received from within an augmented and/or virtual reality environment.

Responsive to receiving the request to invoke the intelligent virtual assistant, the process 200 may include, at step 212, invoking an intelligent virtual assistant associated with an account of the first member of the plurality of group members. At step 214, the process 200 may include receiving a query requesting a response from the intelligent virtual assistant associated with the first member of the plurality of group members.

At step 216, the process 200 may include causing presentation of a response to the received query for consumption by each member of the plurality of group members. According to aspects, the presentation of the response may be in a format that takes into account a context from which the query was received. By way of non-limiting example, if a query is received in the context of a group chat, the response to the received query may be caused to be textually displayed in the context of the group chat such that it is consumable by all members of the chat. By way of non-limiting example, if a query is received in the context of an augmented and/or virtual reality environment, the response to the received query may be caused to be presented within the augmented and/or virtual reality environment and consumable by group members having the appropriate augmented and/or virtual reality equipment.

For example, as described above in relation to FIG. 1, at step 210, the process 200 may include receiving (e.g., through the request receiving module 116 of the system 100 of FIG. 1), from a first member of a plurality of group members, a request to invoke an intelligent virtual assistant. At step 212, the process 200 may include, responsive to receiving the request to invoke the intelligent virtual assistant, invoking (e.g., through intelligent virtual assistant invoking module 118 of the system 100 of FIG. 1) an intelligent virtual assistant associated with an account of the first member of the plurality of group members. At step 214, the process 200 may include receiving (e.g., through the query receiving module 120 of the system 100 of FIG. 1) a query requesting a response from the intelligent virtual assistant associated with the first member of the plurality of group members. At step 216, the process 200 may include causing presentation (e.g., through presenting module 130 of the system 100 of FIG. 1) of a response to the received query for consumption by each member of the plurality of group members.

According to an aspect, the process 200 may include determining that the intelligent virtual assistant associated with the account of the first member of the plurality of group members was invoked for each member of the plurality of group members. By way of non-limiting example, determining that the intelligent virtual assistant associated with the account of the first member of the plurality of group members was invoked for each member of the plurality of group members may include determining, based upon a context from which the query was received, that the intelligent virtual assistant associated with the account of the first member of the plurality of group members was invoked for each member of the plurality of group members. By way of non-limiting example, determining that the intelligent virtual assistant associated with the account of the first member of the plurality of group members was invoked for each member of the plurality of group members may include determining, based upon used of a wake word, that the intelligent virtual assistant associated with the account of the first member of the plurality of group members was invoked for each member of the plurality of group members.

According to an aspect, the process 200 may include identifying the plurality of group members. By way of non-limiting example, identifying the plurality of group members may include identifying the plurality of group members based upon a context from which the request to invoke the intelligent virtual assistant was received. By way of non-limiting example identifying the plurality of group members may include identifying the plurality of group members utilizing one or more sensors of a virtual and/or augmented reality device to detect at least a portion of the plurality of group members.

According to an aspect, the query requesting the response from the intelligent virtual assistant associated with the account of the first member of the plurality of group members may be received from the first member of the plurality of group members. According to an aspect, the query requesting the response from the intelligent virtual assistant associated with the account of the first member of the plurality of group members may be received from a second member of the plurality of group members.

According to an aspect, the process 200 may include collecting data for at least a portion of the plurality of group members. According to an aspect, the process 200 may include determining the response to the received query for each member of the plurality of group members based, at least in part, on the collected data

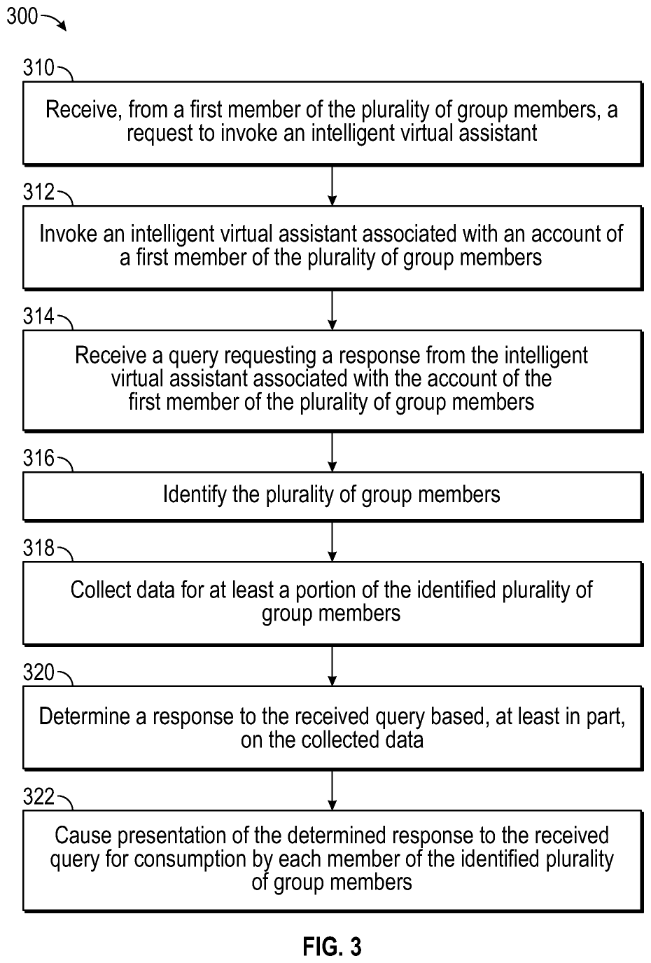

FIG. 3 illustrates an exemplary flow diagram (e.g., process 300) for sharing virtual assistants among group members, according to certain aspects of the disclosure. For explanatory purposes, the exemplary process 300 is described herein with reference to FIG. 1. Further for explanatory purposes, the steps of the example process 300 are described herein as occurring in serial, or linearly. However, multiple instances of the exemplary process 300 may occur in parallel.

At step 310, the process 300 may include receiving, from a first member of a plurality of group members, a request to invoke a virtual assistant. According to aspects, the request to invoke the intelligent virtual assistant may be received in the context of a group communication (e.g., a group chat). According to aspects, the request to invoke the intelligent virtual assistant may be received from within an augmented and/or virtual reality environment.

Responsive to the request to invoke the virtual assistant, the process 300 may include, at step 312, invoking a virtual assistant associated with the first member of the plurality of group members. At step 314, the process may include receiving a query requesting a response from the virtual assistant associated with the first member of the plurality of group members. At step 316, the process 300 may include identifying the plurality of group members. At step 318, the process 300 may include collecting data for at least a portion of the identified plurality of group members. At step 320, the process 300 may include determining a response to the received query for each member of the plurality of group members based, at least in part, on the collected data.

At step 322, the process 300 may include causing presentation of the determined response to the received query for each member of the identified plurality of group members. According to aspects, the presentation of the response may be in a format that takes into account a context from which the query was received. By way of non-limiting example, if a query is received in the context of a group chat, the response to the received query may be caused to be textually displayed in the context of the group chat such that it is consumable by all members of the chat. By way of non-limiting example, if a query is received in the context of an augmented and/or virtual reality environment, the response to the received query may be caused to be presented within the augmented and/or virtual reality environment and consumable by group members having the appropriate augmented and/or virtual reality equipment.

For example, as described above in relation to FIG. 1, at step 310, the process 300 may include receiving (e.g., through the request receiving module 116 of the system 100 of FIG. 1), from a first member of a plurality of group members, a request to invoke a virtual assistant. Responsive to the request to invoke the virtual assistant, the process 300 may include, at step 312, invoking (e.g., through the virtual assistant invoking module 118 of the system 100 of FIG. 1) a virtual assistant associated with the first member of the plurality of group members. At step 314, the process 300 may include receiving (e.g., through the query receiving module 120 of the system 100 of FIG. 1) a query requesting a response from the virtual assistant associated with the first member of the plurality of group members. At step 316, the process 300 may include identifying (e.g., through the group member identifying module 124 of the system 100 of FIG. 1) the plurality of group members. At step 318, the process 300 may include collecting data for at least a portion of the identified plurality of group members (e.g., through the data collecting module 126 of the system 100 of FIG. 1). At step 320, the process 300 may include determining (e.g., through the response determining module 128 of the system 100 of FIG. 1) a response to the received query for each member of the plurality of group members based, at least in part, on the collected data. At step 322, the process 300 may include causing presentation of the determined response to the received query for each member of the identified plurality of group members (e.g., through the presenting module 130 of the system 100 of FIG. 1).

According to an aspect, the process 300 may include determining that the intelligent virtual assistant associated with the account of the first member of the plurality of group members was invoked for each member of the plurality of group members. By way of non-limiting example, determining that the intelligent virtual assistant associated with the account of the first member of the plurality of group members was invoked for each member of the plurality of group members may be based upon a context from which the query was received. By way of non-limiting example, determining that the intelligent virtual assistant associated with the account of the first member of the plurality of group members was invoked for each member of the plurality of group members may be based upon used of a wake word.

In aspects, the process 300 may include identifying the plurality of group members based upon a context from which the request to invoke the intelligent virtual assistant was received. In aspects, the process 300 may include identifying the plurality of group members utilizing one or more sensors of a virtual and/or augmented reality device to detect at least a portion of the plurality of group members.

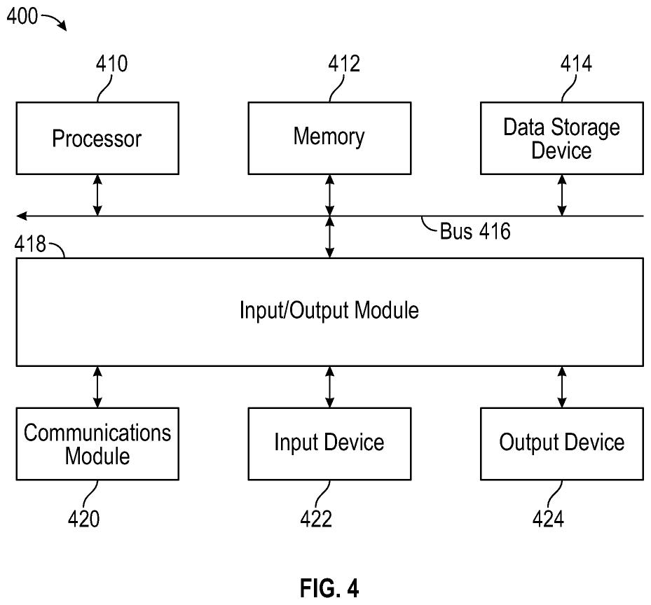

FIG. 4 is a block diagram illustrating an exemplary computer system 400 with which aspects of the subject technology can be implemented. In certain aspects, the computer system 400 may be implemented using hardware or a combination of software and hardware, either in a dedicated server, integrated into another entity, or distributed across multiple entities.

Computer system 400 (e.g., server and/or client) includes a bus 416 or other communication mechanism for communicating information, and a processor 410 coupled with bus 416 for processing information. By way of example, the computer system 400 may be implemented with one or more processors 410. Processor 410 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, e.g., code that constitutes processor firmware, a protocol stack, a database management system, an operating system, or a combination of one or more of them stored in an included memory 412, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 416 for storing information and instructions to be executed by processor 410. The processor 410 and the memory 412 can be supplemented by, or incorporated in, special purpose logic circuitry.

The instructions may be stored in the memory 412 and implemented in one or more computer program products, i.e., one or more modules of computer program instructions encoded on a computer readable medium for execution by, or to control the operation of, the computer system 400, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 416 may also be used for storing temporary variable or other intermediate information during execution of instructions to be executed by processor 410.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 400 further includes a data storage device 414 such as a magnetic disk or optical disk, coupled to bus 416 for storing information and instructions. Computer system 400 may be coupled via input/output module 418 to various devices. The input/output module 418 can be any input/output module. Exemplary input/output modules 418 include data ports such as USB ports. The input/output module 418 is configured to connect to a communications module 420. Exemplary communications modules 420 include networking interface cards, such as Ethernet cards and modems. In certain aspects, the input/output module 418 is configured to connect to a plurality of devices, such as an input device 422 and/or an output device 424. Exemplary input devices 422 include a keyboard and a pointing device, e.g., a mouse or a trackball, by which a user can provide input to the computer system 400. Other kinds of input devices 422 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 424 include display devices such as a LCD (liquid crystal display) monitor, for displaying information to the user.

According to one aspect of the present disclosure, the above-described gaming systems can be implemented using a computer system 400 in response to processor 410 executing one or more sequences of one or more instructions contained in memory 412. Such instructions may be read into memory 412 from another machine-readable medium, such as data storage device 414. Execution of the sequences of instructions contained in the main memory 414 causes processor 412 to perform the process steps described herein. One or more processors in a multi-processing arrangement may also be employed to execute the sequences of instructions contained in memory 414. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 400 can include clients and servers. A client and server are generally remote from each other and typically interact through a communication network. The relationship of client and server arises by virtue of computer programs running on the respective computers and having a client-server relationship to each other. Computer system 400 can be, for example, and without limitation, a desktop computer, laptop computer, or tablet computer. Computer system 400 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 410 for execution. Such a medium may take many forms, including, but not limited to, non-volatile media, volatile media, and transmission media. Non-volatile media include, for example, optical or magnetic disks, such as data storage device 414. Volatile media include dynamic memory, such as memory 412. Transmission media include coaxial cables, copper wire, and fiber optics, including the wires that comprise bus 416. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 400 reads data, information may be read from the data and stored in a memory device, such as the memory 412. Additionally, data from the memory 412 servers accessed via a network, the bus 416, or the data storage 414 may be read and loaded into the memory 412. Although data is described as being found in the memory 412, it will be understood that data does not have to be stored in the memory 412 and may be stored in other memory accessible to the processor 410 or distributed among several media, such as the data storage 414.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include”, “have”, or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration”. Any embodiment described herein as “exemplary” is not necessarily to be construed as preferred or advantageous over other embodiments.

A reference to an element in the singular is not intended to mean “one and only one” unless specifically stated, but rather “one or more”. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

1. A computer-implemented method for sharing intelligent virtual assistants among a plurality of group members, the method comprising:
receiving, from a first member of the plurality of group members, a request to invoke an intelligent virtual assistant;
responsive to receiving the request to invoke the intelligent virtual assistant, invoking an intelligent virtual assistant associated with an account of the first member of the plurality of group members;
receiving a query from the first member of the plurality of group members requesting a response from the intelligent virtual assistant associated with the account of the first member of the plurality of group members; and
causing presentation of a response to the received query for consumption by each member of the plurality of group members.

2. The computer-implemented method of claim 1, further comprising determining that the intelligent virtual assistant associated with the account of the first member of the plurality of group members was invoked for each member of the plurality of group members.

3. The computer-implemented method of claim 2, wherein determining that the intelligent virtual assistant associated with the account of the first member of the plurality of group members was invoked for each member of the plurality of group members comprises determining, based upon a context from which the query was received, that the intelligent virtual assistant associated with the account of the first member of the plurality of group members was invoked for each member of the plurality of group members.

4. The computer-implemented method of claim 2, wherein determining that the intelligent virtual assistant associated with the account of the first member of the plurality of group members was invoked for each member of the plurality of group members comprises determining, based upon a wake word, that the intelligent virtual assistant associated with the account of the first member of the plurality of group members was invoked for each member of the plurality of group members.

5. The computer-implemented method of claim 1, further comprising identifying the plurality of group members.

6. The computer-implemented method of claim 5, wherein identifying the plurality of group members comprises identifying the plurality of group members based upon a context from which the request to invoke the intelligent virtual assistant was received.

7. The computer-implemented method of claim 5, wherein identifying the plurality of group members comprises identifying the plurality of group members utilizing one or more sensors of a virtual and/or augmented reality device to detect at least a portion of the plurality of group members.

8. (canceled)

9. The computer-implemented method of claim 1, wherein the query requesting the response from the intelligent virtual assistant associated with the account of the first member of the plurality of group members is received from a second member of the plurality of group members.

10. The computer-implemented method of claim 1, further comprising:
collecting data for at least a portion of the plurality of group members; and
determining the response to the received query for each member of the plurality of group members based, at least in part, on the collected data.

11. A system configured for sharing intelligent virtual assistants among a plurality of group members, the system comprising:
one or more hardware processors configured by machine-readable instructions to:
receive, from a first member of the plurality of group members, a request to invoke an intelligent virtual assistant;
responsive to receiving the request to invoke the intelligent virtual assistant, invoke an intelligent virtual assistant associated with an account of the first member of the plurality of group members;
receive a query from the first member of the plurality of group members requesting a response from the intelligent virtual assistant associated with the account of the first member of the plurality of group members;
identify the plurality of group members;
collect data for at least a portion of the identified plurality of group members;
determine a response to the received query based, at least in part, on the collected data; and
cause presentation of the determined response to the received query for consumption by each member of the identified plurality of group members.

12. The system of claim 11, wherein the one or more hardware processors are further configured by machine-readable instructions to determine that the intelligent virtual assistant associated with the account of the first member of the plurality of group members was invoked for each member of the plurality of group members.

13. The system of claim 12, wherein the one or more hardware processors are further configured by machine-readable instructions to determine that the intelligent virtual assistant associated with the account of the first member of the plurality of group members was invoked for each member of the plurality of group members based upon a context from which the query was received.

14. The system of claim 12, wherein the one or more hardware processors are further configured by machine-readable instructions to determine that the intelligent virtual assistant associated with the account of the first member of the plurality of group members was invoked for each member of the plurality of group members based upon used of a wake word.

15. The system of claim 11, wherein the one or more hardware processors are further configured by machine-readable instructions to identify the plurality of group members based upon a context from which the request to invoke the intelligent virtual assistant was received.

16. The system of claim 11, wherein the one or more hardware processors are further configured by machine-readable instructions to identify the plurality of group members utilizing one or more sensors of a virtual and/or augmented reality device to detect at least a portion of the plurality of group members.

17. A non-transient computer-readable storage medium having instructions embodied thereon, the instructions being executable by one or more processors to perform a method for sharing virtual assistants among a plurality of group members, the method comprising:
receiving, from a first member of the plurality of group members, a request to invoke an intelligent virtual assistant;
responsive to receiving the request to invoke the intelligent virtual assistant, invoking an intelligent virtual assistant associated with an account of the first member of the plurality of group members;
receiving a query from the first member of the plurality of group members requesting a response from the intelligent virtual assistant associated with the account of the first member of the plurality of group members; and
causing presentation of a response to the received query for consumption by each member of the plurality of group members.

18. The computer-readable storage medium of claim 17, wherein the method further comprises determining that the intelligent virtual assistant associated with the account of the first member of the plurality of group members was invoked for each member of the plurality of group members based, at least in part, on a context from which the request to invoke the intelligent virtual assistant was received.

19. The computer-storage medium of claim 17, wherein the method further comprises identifying the plurality of group members based, at least in part, upon a context from which the request to invoke the intelligent virtual assistant was received.

20. The computer-storage medium of claim 17, wherein the method further comprises:
collecting data for at least a portion of the plurality of group members; and
determining the response to the received query based, at least in part, on the collected data.
